(19) United States
(12) Patent Application Publication
(10) Pub. No.: US 2014/0282099 A1
(43) Pub. Date: Sep. 18, 2014

(54) RETRIEVAL, IDENTIFICATION, AND PRESENTATION OF MEDIA

(71) Applicant: Apple Inc., Cupertino, CA (US)

(72) Inventors: Kjell F. Bronder, San Francisco, CA (US); Eric Circlaeys, Paris (FR); Ralf Weber, San Jose, CA (US); Jason Wilson, Mill Valley, CA (US)

(73) Assignee: Apple Inc., Cupertino, CA (US)

(21) Appl. No.: 13/891,467

(22) Filed: May 10, 2013

Related U.S. Application Data
(60) Provisional application No. 61/783,377, filed on Mar. 14, 2013.

(51) Int. Cl. H04L 29/06

(52) U.S. Cl. CPC H04L 65/403
USPC 715/753

(57) ABSTRACT

Techniques are provided for concurrently displaying a plurality of media items from different sources, such as different computing devices of a user or social network providers with which the user has an account or with which the user has a social connection to an account. Media items may include digital images, video, text, and executables, or icons thereof. The media items may be analyzed to identify one or more different sets of media items, each set being associated with different criteria. Example criteria include a particular time range, a particular person, and a particular location. Once a set of media items is identified, each media item in the set is assigned to a group based on grouping criteria and displayed based on the group to which the media item belongs.

### CROSS-REFERENCE TO RELATED APPLICATIONS; BENEFIT CLAIM

This application claims the benefit of U.S. Provisional Application No. 61/783,377, filed Mar. 14, 2013, the entire contents of which is hereby incorporated by reference as if fully set forth herein, under 35 U.S.C. §119(e).

### FIELD OF THE INVENTION

The present invention generally relates to displaying media items and, more particularly, to retrieving media items from different sources and concurrently displaying the media items.

### BACKGROUND

Due to the portability and relative affordability of electronic devices, many people own or operate multiple electronic devices, such as smartphones, laptop computers, tablet computers, and desktop computers. Recent years have seen the popularity explosion of social media services, such as Facebook, Instagram, and Twitter. Each of these phenomena has contributed to the ability for a user to store different media items (such as digital images) in different locations. However, these two phenomena together have compounded the problem of a user attempting to locate certain media items, which may be stored in many different locations. If, for example, a user desires to view all images that were taken by the user within a particular month and the user is not sure if a single storage location contains all such images, then the user must manually check multiple storage locations (e.g., multiple computing devices and third-party services) in order to locate all such images.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system architecture, in an embodiment;

FIG. 2 is a flow diagram that depicts a process for displaying multiple media items from different sources concurrently on a display, in an embodiment;

FIG. 3 is a screen shot that depicts an example settings display that allows a user to register (or connect) an account of the user with one or more applications executing on the user's device, in an embodiment;

FIG. 4 is a screen shot that depicts a media wall that includes multiple media items from different sources, in an embodiment;

FIG. 5 is a screen shot that depicts a media menu that allows a user to initiate the display of a different set of media items than those that are currently displayed, in an embodiment;

FIG. 6 is a screen shot that depicts a media menu after a “People” option has been selected, in an embodiment;

FIG. 7 is a screen shot that depicts a media wall after a particular name of a person has been selected, in an embodiment;

FIG. 8-29 are screen shots that depict media walls and/or media menus after various user selections, in an embodiment;

FIG. 30-39 are screen shots of displays provided by an application that leverages a media browser for displaying media items to be used in the application, in an embodiment;

FIG. 40 is a screen shot that depicts a display after a user has submitted a search query, in an embodiment;

FIGS. 41-44 are diagrams that depict instances of a media menu after navigating through various menu options, in an embodiment; and

FIG. 45 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the common vernacular, a digital picture or digital image may either refer to an image file that may be processed to display an image or the actual image itself. As used herein, digital image data refers to digital data that may be processed to display a digital image or photo. For example, non-limiting, illustrative examples of digital image data include a .BMP file, a .JPEG file, a .TIF file, or a .GIF file. Thus, a digital image or photo is the visual display of digital image data. However, in contexts where the distinction between the visual image rendered from digital image data and the digital image data itself is not important to understand how the embodiment of the invention works, a reference to a digital image or photo may follow the common vernacular and implicitly include reference to the digital image data used to display the digital image or digital picture. For example, a description of “storing a digital image” refers to storing digital image data which, when processed, causes the display of the digital image.

### General Overview

Techniques are provided herein for retrieving media items from different sources and presenting the media items concurrently on a display screen. At least one of the different sources may include the same device that causes the media items to be displayed. Other sources may include other devices owned by a user and/or social network accounts registered to the user. Other sources may include accounts of “friends” or contacts of the user.

Embodiments involve not only allowing a user to view media items to which the user has access, but also allowing a user to view media items within other users' accounts in which the other users have given the user access.

Retrieved media items may be displayed in many different formats and may be grouped in many different ways. Examples of formats and groupings are provided in more detail below.

Although many of the figures and examples herein describe or depict digital images, media items include other types of items, such as audio files, video files, text files, etc.

### System Overview

FIG. 1 is a block diagram that depicts an example system architecture 100, in an embodiment. System architecture 100 includes a client device 110, a network 120, and remote sources 132, 134, and 136. Client device 110 is a computing device that includes media browser 112, storage 114 and a display (not shown). Examples of client device 110 include a desktop computer, a laptop computer, a tablet computer, a smartphone, a smart TV, a smart watch and the like. Client device 110 may execute one or more software applications (not shown).

Storage 114 may be volatile storage, non-volatile storage, or a combination of volatile and non-volatile storage. Examples of storage 114 include a hard disk, SD card, DRAM, and SDRAM.

The display of client device 110 may be integrated into client device 110, such as a touchscreen on a smartphone or tablet computer. Alternatively, the display may be separate from, but communicatively coupled to, client device 110 (e.g., a Television connected to a computing device).

Media browser 112 is configured to receive media items from one or more of remote sources 132-136 and, optionally, from (local) storage 114, and to cause the retrieved media items to be displayed. Local storage 114 may be viewed as a single local source or multiple local sources. For example, a computer may host multiple applications (e.g., iPhoto, iMovie, iTunes), each of which accesses different portions of storage 114.

Media browser 112 may be implemented in software, hardware, firmware or any combination thereof. Media browser 112 may consist of multiple modules or components, such as a retrieval component and a display component. The retrieval component is primarily responsible for retrieving media items from multiple sources while the display component is primarily responsible for determining which media items to display and how. In an embodiment, the display component may comprise multiple components, such as a stream media component that is responsible for identifying media items that satisfy one or more criteria and a layout component that is responsible for rendering a display of media items that have been identified.

In a related embodiment, media browser 112 is a web application that executes on one or more web servers (not shown) that are accessible to many client devices. A web server is typically not as resource-constrained as end-user devices, such as a tablet computer. In such a configuration, client device 110 executes a web browser (not shown) that communicates over network 120 with media browser 112 to allow a user of client device 110 to log in to media browser 112 and to retrieve media items from multiple sources and display those media items via the web browser on a display of client device 110.

Examples of media items include digital images, video files, audio files, text files, and executable files. “Displaying” a media item involves displaying all or a portion of the media item (e.g., a portion of a text document, or a frame in a video file), a smaller version of the media item (e.g., a thumbnail version of a digital image), or an icon that represents the media item, such as an icon for an executable file or for a text document.

Network 120 may be implemented by any medium or mechanism that provides for the exchange of data between client device 110 and remote sources 132-136. Examples of network 120 include, without limitation, a network such as a Local Area Network (LAN), Wide Area Network (WAN), Ethernet or the Internet, or one or more terrestrial, satellite or wireless links.

Remote sources 132-136 store or have access to media items that may be sent to (and requested by) media browser 112. Examples of remote sources 132-136 include other computing devices owned or operated by a user of client device 110, social network providers (such as Facebook, Twitter, Instagram, Google+), and third party storage services (such as Picasa and DropBox). Thus, remote sources 132-136 may be provided by different parties.

One or more of remote sources 132-136 may require user authentication before granting access to media items by media browser 112. For example, user A of client device 110 has established user accounts at Facebook and Twitter. The user accounts are said to be “registered” to user A. User authentication of user A may be required for media browser 112 to access media items from those two sources. Additionally or alternatively, one or more of remote sources 132-136 allows unrestricted access to media items associated with (or owned by) user A. In that case, an identifier that uniquely identifies the user may be the only piece of data that is required for media browser 112 to access media items from that remote source.

As noted above, an example of one of remote sources 132-136 is a second computing device (e.g., laptop computer) (not shown) owned by the user of client device 110. In order to communicate with the second computing device, client device 110 and the second computing device may be registered with a network service that allows each device to request or access data from the other device. Thus, in order to access data from the second computing device, client device 110 may send a request that is directed to the network service and that identifies the second computing device. The network service may then forward the request (or modify the request and send the modified request) to the second computing device.

Remote sources 132-136 may send the entirety of a requested media item or a portion of a requested media item to client device 110. For example, remote source 132 may send a smaller resolution version of a digital image to which remote source 132 has access.

### Access to Media Items of “Friends”

Many social network providers allow a user to access media items and other content that are available in accounts other than the user's accounts. Such other accounts may be accounts of “friends” of the user. A “friend” or contact of a user, with respect to a service provider, is an individual that has provided input that allows the user to contact the individual through the service provider. Both the user and the individual have registered with the service provider. Thus, if user A has established a relationship with user B through service provider S, then user A is, thereafter, able to communicate with user B through service provider S. Examples of service provider S include an instant messaging service and a social network service, such as Facebook and LinkedIn.

Thus, for example, user A may view photos uploaded by user B to user B's account. In an embodiment, media items that are retrieved from a social network provider include media items that were uploaded by another user to their own account. Thus, media browser 112 is able to not only retrieve and display media items that a user has created, uploaded, or manipulated in some manner, but also retrieve (potentially-relevant) media items that the user has never seen before, but to which the user has access through social or other network providers. Such media items may include digital images and video uploaded by the user's friends and, optionally, any associated metadata of the media items, such as comments, tags, likes, etc.

### Storing Retrieved Media Items

In an embodiment, media items that are retrieved from multiple sources are stored persistently on client device 110. In this way, media browser 112 is not required to retrieve the same media items from a particular source multiple times. The media items stored on client device 110 may be stored in association with the sources from which the media items were retrieved. For example, first storage data that identifies remote source 132 is stored in association with a first media item that was retrieved from remote source 132 while second storage data that identifies remote source 134 is stored in association with a second media item that was retrieved from remote source 134.

In a related embodiment, storage available on client device 110 is divided or partitioned based on the sources from which media items are retrieved. For example, storage partition A stores media items that were retrieved from remote source 132 while storage partition B stores media items that were retrieved from remote source 134. The size of a storage partition may be increased or decreased depending on the number of media items in the storage partition and/or other storage partitions.

In an embodiment, media browser 112 stores data that indicates the most recently-retrieved media items from a particular source. Such data is referred to herein as “last retrieval data.” For example, media browser 112 stores a timestamp that is associated with remote source 132. Media browser 112 uses the timestamp to retrieve only media items that were stored at remote source 132 after the date and/or time indicated by the timestamp. As another example, media browser 112 stores data that identifies the most recent media item that was retrieved from remote source 132. Media browser 112 uses that particular media item to retrieve only media items that were uploaded to remote source 132 after that particular media item was uploaded to remote source 132.

In a related embodiment, different sources may be associated with different types of last retrieval data. For example, a timestamp may be stored in association with remote source 132 while an identifier that identifies a media item may be stored in association with local storage 114.

In an embodiment, media items may be deleted or modified based on one or more criteria. The one or more criteria may be different from one computing device to another, depending, for example, on the memory capacity of the computing device upon which media browser 112 executes. For example, if a storage limit for media items is approached, then media items that have been least recently accessed or displayed may be deleted from persistent storage. As another example, high resolution representations of media items may be removed or deleted over time (e.g., based on access/display frequency or based on time) while low resolution representations of the media items are retained. In this way, media browser 112 is able to display the media item to a user when the user desires to view the media item. Additionally, while a low resolution representation of a media item is displayed, media browser 112 may send, to the appropriate source, a request for a high resolution version of the media item and then update the display when the high resolution version is retrieved.

### Duplicate Media Item Detection within a Source

In an embodiment, media browser 112 retrieves media items from a particular source and performs duplicate media item detection on those media items relative to media items that have already been retrieved from the particular source. Such an embodiment is useful if media browser 112 is not configured to request only media items that have not already been retrieved. A duplicate media item may be deleted from persistent storage or, instead, may be “suppressed” at display time.

Duplicate detection may be performed by comparing metadata information of various media items. For example, comparing names, sizes, and dates associated with two media items may indicate that the two media items are the same and, thus, one of the two media items may be deleted. As another example, if the sizes or names of two media items are different, then the two media items may be considered different, despite all other metadata information being the same.

Additionally or alternatively, duplicate detection may involve comparing the content of two media items. For example, a “footprint” of each media item is calculated based on the color schemes of the media items and then compared to each other. As another example, a root mean square (RMS) is calculated for each media item and then compared to each other.

### Example Display Process

FIG. 2 is a flow diagram that depicts a process 200 for displaying multiple media items from different sources concurrently on a display, in an embodiment. Process 200 may be implemented by media browser 112 executing on client device 110. Client device 110 includes (or is communicatively coupled to) a display for displaying media items, such as digital images, video, and icons associated with text documents, software applications, audio items, video items, etc. Alternatively, process 200 may be implemented by a server computer that retrieves the multiple media items from different sources and sends the media items to a client device, which displays the media items.

At block 210, a first set of media items is retrieved from a first source. The first source may be local or remote relative to the process or entity that implements process 200. For example, if a client device implements process 200, then the first source may be storage that is included in (or connected directly to) the client device, such as a hard disk or an SD card. As another example, the first source may be a computing device that is different than client device 110, which is to display at least a portion of the first set of media items.

At block 220, a request for media items is sent over a network to a second source that is different than the first source. For example, media browser 112 sends a request, over network 120, to remote source 132. In an embodiment, block 220 involves sending multiple requests simultaneously, each request being sent to a different source.

At block 230, a second set of media items is received from the second source. For example, media browser 112 receives at least one digital image from remote source 132.

At block 240, the first and second sets of media items are concurrently displayed. Block 240 may involve media browser 112 determining, based on one or more criteria, how to arrange the first and second sets of media items on a display of client device 110.

### Example Retrieval Process

In an embodiment, the content of media items is not requested from one or more sources until media browser 112 receives a request to display the content. For example, for each source, media browser issues, to the source, a batch query to retrieve a list of media identifiers. In response, the source sends the list to media browser 112. For each source, media browser 112 compares the received list of media identifiers with media identifiers in a metadata cache that is associated with the source. In other words, media browser 112 maintains a metadata cache for each source. A metadata cache includes for each media item, a media item identifier and one or more other metadata, such as size of content of the media item, a date associated with the media item, a location associated with the media item, one or more names of one or more people associated with (e.g., depicted in) the media item, aspect ratio (for digital images), likes, and comments. In this way, media browser 112 can determine which media items have been added (if any) to the source and which media items have been removed from the source.

If no new media items are detected based on the identifier comparison (with respect to a particular source), then no further query is issued to the particular source. Otherwise, media browser 112 issues another batch query to the particular source to retrieve metadata (i.e., more than just an identifier, such as date, time, people, comments, likes, etc.) for each newly discovered media item. For example, the batch query may only include identifiers for the newly discovered media item. If a source's metadata cache is empty (i.e., a “cold cache”), then this subsequent batch query is for metadata of all the media items identified in the list. In response to the subsequent batch query, the source sends the requested metadata to media browser 112.

At this point, media browser 112 still does not have any of the media content (including thumbnails) associated with the requested metadata (or associated with existing metadata in the metadata cache). In some embodiments, media browser 112 does not send, to one or more sources, a request (or requests) for such content until media browser 112 receives a request (e.g., initiated by a user) to display a media stream that requires the content.

### Registering a Remote Source

In an embodiment, media browser 112 is configured to allow a user to register one or more remote sources with media browser 112. “Registering” a remote source may involve the user providing a user name and password (and/or other user credentials) that the user provides the remote source when accessing the user's account maintained by the remote source. Once a remote source is registered with media browser 112, media browser 112 will not have to prompt the user again for user credentials before retrieving media items from the remote source.

FIG. 3 is a screen diagram that depicts an example settings display that allows a user to register (or connect) an account of the user with one or more applications executing on the user's device, in an embodiment. An example of the user's device is client device 110. The account of the user is maintained by a third party, which, in this example, is Facebook. The applications include “Media Wall,” which may correspond to media browser 112, described previously. In this example, the setting display indicates that the application “Media Wall” is allowed to access or retrieve media items from Facebook. Based on this setting, the application “Media Wall” is able to send a request to Facebook where the (e.g., initial) request includes user authentication information, such as a username and password, to allow the application to request data maintained by Facebook.

In this example, the requested data includes digital images and, optionally, metadata and other data associated with the digital images. Examples of metadata and other data associated with a digital image include a quality metric (e.g., resolution) of the digital image, an author of the digital image, a date and/or time of the digital image, an indication of a geographical location of the digital image, comments from “friends” of the user regarding the digital image (including an identification of those friends), a number of “Likes” of the digital image (including an identification of those who “liked” the digital image), an identification of each (or at least one) person (e.g., “George Smith”) or other object (e.g., “Eiffel Tower”) reflected in the digital image, and a number of people or “friends” reflected in the digital image.

In an embodiment, one or more remote sources have “system support” while one or more other remote sources do not have “system support.” For example, Facebook and Twitter may have system support and Instagram may not have system support. “System support” means that an operating system (OS) of client device 110 has built-in support for a remote source. The OS is aware of the user account at the remote source and can give that account information to an application if the application is given access. In this way, a developer of media browser 112 is not required to write code to support authentication, etc.

### Media Wall

FIG. 4 is a screen shot that depicts a media wall 400 that includes multiple media items from different sources, in an embodiment. For example, media item 410 may be retrieved from local storage 114 while media item 420 is retrieved from a source that is different than the computing device that displays the media items. Media wall 400 may be displayed on a display of client device 110.

Media wall 400 may be a default wall, such as when a user “opens” media browser 112, such as by selecting an icon that represents media browser 112. A default wall may include all media items to which the user has access. Alternatively, a default wall may include all media items that satisfy one or more criteria, such as being associated with a certain date range or being associated with certain people. Any criteria associated with the default wall may be modified by a user.

The media items that qualify for inclusion in a media wall, regardless of whether all the media items may be displayed simultaneously, are referred to herein as a “media stream” that is associated with the media wall. The one or more criteria that are used to determine whether a media item qualifies for inclusion in a media wall are referred to herein as “stream criteria.” Thus, a media stream includes one or more media items that satisfy one or more stream criteria that are associated with the media stream. Media items that satisfy one or more stream criteria are said to “belong” to the media stream and the media wall that is associated with the one or more stream criteria. Thus, different media streams are associated with different stream criteria.

While embodiments are described in the context of displaying and searching media items that are retrieved from different sources, embodiments are not limited to that context. In some embodiments, the context involves media items that are retrieved from or found in a single source.

### Order and Size of Media Items

The media items in a media stream may be ordered based on one or more order criteria, such as time, location, popularity, and/or person identity. Thus, after media browser 112 determines a set of media items that satisfy one or more stream criteria, media browser 112 may determine how to order the set of media items on a media wall based on, for example, a time of day or date associated with each media item in the set. Alternatively, media browser 112 may randomly select, for display, media items from the set of media items that belong to a media stream.

In the depicted example, the digital images in media wall 400 are of different sizes and aspect ratios. In a different embodiment, all digital images depicted in media wall 400 have the same aspect ratio (e.g., 4:3) and/or resolution. Different layout options for media items in a media wall are described in more detail below.

The size of a media item in media wall 400 may be determined by media browser 112 based on one or more size criteria. Examples of the size criteria include popularity and a number of people reflected in the media item. Popularity may be based on one or more factors, such as a number of people who “liked” a media item, a number of people who “commented” on a media item, a number of “friends” of the user who are reflected in a media item, and whether the user and a “close” friend are reflected in a media item.

### Item Source Indicator

In an embodiment, a media item that is displayed in a media wall includes an item source indicator. An item source indicator is data that indicates a source of the media item with which the item source indicator is associated. An item source indicator may be text, an icon, or other graphic. In one embodiment, an item source indicator is overlaid on a media item, such that the media item and the item source indicator are visible simultaneously. In another embodiment, an item source indicator is displayed only in response to input that selects the corresponding media item or that selects an option (not depicted) to view sources of multiple media items that are displayed in a media wall.

In the depicted example, each digital image in media wall 400 includes an item source indicator. For example, item source indicator 412 on media item 410 may indicate that media item 410 was retrieved from local storage 114 while item source indicator 422 on media item 420 indicates that media item 420 was retrieved from Facebook.

In an embodiment, if media browser 112 detects that if a media item in a media wall is from multiple sources, then the media wall includes information that indicates that the media item was found from multiple sources. The information may involve the display of two or more item source indicators on the media item. For example, the two or more item source indicators may be stacked on top of each other.

### Media Wall: Scrolling

In an embodiment, if a media wall is not large enough to contain all media items that belong to a media stream, then the media wall becomes “scrollable.” In other words, in response to input from a user, the display of the media wall changes to include additional media items that were not previously displayed and exclude media items that were previously displayed.

A user is able to scroll through media wall (such as media wall 400) through one or more input mechanisms, such as a mouse, voice commands, keyboard, or touchscreen. The scrolling may be vertical (such as top to bottom) or horizontal (such as left to right). For example, in order to scroll through media wall 400, a user swipes a finger on a touchscreen from right to left in order to view media items that are to the “right” of the currently-displayed media items.

### Media Wall: Accelerated Scrolling

In some cases, the number of media items that belong to a media stream may greatly exceed the number of media items that may fit in a media wall, thus requiring a user to perform a significant amount of scrolling in order to view all the media items in the media stream. In an embodiment, to address this issue, media browser 112 allows a user to initiate accelerated scrolling of a media wall (such as media wall 400). “Accelerated scrolling” is scrolling that is faster than scrolling that can be initiated by normal scroll initiation input, such as holding down an arrow key, swiping a finger across a touchscreen, or selecting a scroll button on a user interface with a cursor. With touchscreen devices, “normal” scrolling speed may be the scrolling speed that corresponds to the speed of a finger swipe. Thus, a fast swipe of a finger across a touchscreen will cause a media wall to scroll faster than a slow swipe of the finger across the touchscreen.

In an embodiment, accelerated scrolling is initiated by a user dragging or swiping multiple fingers across a media wall. For example, if a user drags two fingers on a touchscreen in a particular direction (e.g., horizontal), then scrolling is accelerated by four times (4×) the normal scrolling speed. As another example, if a user drags three fingers on a touchscreen in a particular direction, then scrolling is accelerated by eight times (8×) the normal scrolling speed.

In a related embodiment, while in accelerated mode, media browser 112 causes a heads-up display (HUD) that indicates context of what images in a media wall are currently being (or about to be) displayed. For example, if a media wall is organized by date, then the HUD may indicate a specific date or a month and year. As another example, if a media wall is organized by location, then the HUD may indicate a city and/or country. As another example, if a media wall is organized by person, then the HUD may indicate a name of a person and, optionally, a date.

In an embodiment, a media wall includes a scroll bar that, when moved based on input from a user, media items in the media wall do not change until the user “let's go” of the scroll bar. While the scroll bar is engaged (e.g., a cursor button is depressed while the scroll bar is selected), a HUD is displayed that includes an example set of media items at the position in the media wall that corresponds to the position of the scroll bar and/or a description of the context. Similar to the HUD described previously, if, for example, the media wall is organized by date, then the description may indicate a specific data, month, or year. If the media wall is organized by location, then the description may indicate a city, country, or geographical location.

### Fullscreen Mode

In an embodiment, user selection of a media item in a media wall causes media browser 112 to enter a mode that focuses on the media item. For example, if the selected media item is a digital image, then media browser 112 enters a full image mode where the selected digital image occupies a majority of the screen space occupied by media browser 112. Thus, for example, media item 410 occupies a relatively large portion of media wall 400.

Once in full image mode, the user may provide input relative to the selected media item. For example, a user may provide input (e.g., a “pinch close” on a touchscreen) that causes the display of the media item to shrink in size (or “zoom out”) or input (e.g., a “pinch open”) that causes the display of the media item to expand in size (or “zoom in”). As another example, a user may provide input to scroll through media items one at a time, such as by swiping the displayed media item from right to left. As another example, if the selected media item corresponds to a video file, then media browser 112 enters a playback mode where the selected video file is played or at least controls for navigating the video file are displayed, such as play, stop, pause, rewind, and forward controls.

### Duplicate Media Item Detection within a Media Wall

In an embodiment, media item duplicate detection is performed to avoid displaying media items that are identical. In some situations, multiple sources may store a copy of the same media item. For example, a user transfers a digital image from her camera to her laptop computer, after which the user uploads a copy of the digital image from the laptop computer to her Facebook account. Later, when media browser 112 executing on the laptop computer retrieves media items from multiple sources, those sources might include the laptop computer and the user's Facebook account. Thus, media browser 112 might display both copies of the digital image.

Any technique may be used to determine that two media items are copies of each other. For example, the content of the media items may be compared. In the case of digital images, an image footprint algorithm may be used to generate “footprints” of two digital images and then the footprints are compared to determine whether the two digital images are similar enough. If so, then the two digital images are deemed the same. A “footprint” of an image is data that describes one or more features detected in the image. An image footprint is typically much smaller than the image from which the image footprint was generated. Alternatively to an image footprint algorithm, color RMS may be used to determine whether two digital images are the same.

As another example, each media item may include an identifier that may be used as a roughly “unique” identifier. For example, the identifier may be an identifier generated by a camera that generated the initial copy of a media item. The identifier may be transferred along with the media item to one or more other devices. Another proxy UID may be a name of the media item. If the names of two media items are the same, then further analysis may be performed on both media items to determine whether they are the same media item, such as comparing content of the two media items.

### Clustering: Selecting Media Streams

As noted previously, media items from multiple sources may be grouped or clustered according to one or more stream criteria, regardless of the sources of the media items. A media item may belong to different media streams, depending on the current one or more stream criteria that are applied at a given moment. FIGS. 5-11 illustrate different UI menu options for allowing a user to select stream criteria for filtering stream results.

FIG. 5 is a screen shot that depicts a media menu 510 that allows a user to initiate the display of a different set of media items than those that are currently displayed, in an embodiment. Media menu 510 may be displayed in response to a user selecting “All My Media” button 502 or in response to the user providing certain voice input. Media menu 510 includes five options: “All My Media” option (which is currently selected by default or by a user), a “Smart Groups” option, a “People” option, a “VIP” option, and a “Library” option. Each of the listed options allows a user to select one or more criteria that is used to determine which media items (from multiple sources) to display. Each of the listed options is described in more detail below.

### People-Centric Menu Option

For many users, it is not intuitive to search for media items based on what source the media item is coming from. Rather, it is intuitive to search for media items based on people who are associated with (or depicted in) those media items. In other words, many users do not want to worry about whether certain media items are coming from Photo Stream, Facebook, or Flickr. In an embodiment, media browser 112 allows a user to create (virtual) media streams, one for each person in which the user is interested, regardless of where the media items in those media streams originate. A person may be associated with a media item if the person, for example, caused the media item to be created, owns a device to which the media item was sent, is detected in the media item (such as the person's face or voice), or is identified in metadata associated with the media item.

FIG. 6 is a screen shot that depicts a media menu 610 after the “People” option has been selected, in an embodiment. Media menu 610 includes a list of names in alphabetical order (although order is not necessary). The names that are included in the list may have been identified in data from one or more of remote sources 132-136. For example, “Rachel M.” may have been identified in data from remote source 132 while “Rachel R.” may have been identified in data from remote source 134.

With the explosion of social media, many users have hundreds of “friends” or contacts. Thus, the list of people whose pictures a typical user has access to is relatively large. To address this issue, in an embodiment, media browser 112 supports the designation of “VIPs” or “Favorites” in order to allow a user to specify which people the user is most interested in. For example, in response to user input associated with a given name, an indicator (e.g., a “star”) is displayed next to the given name. The user input may involve (1) the user right-clicking the given name, which causes a menu to appear, and (2) the user selecting a “VIP” menu option in k link 4520 and through communication interface 4518, whelection input and is being displayed may be displayed with the (e.g., star) indicator. Then, media browser 112 may aggregate all the media items associated with any name in the VIP list into a single media wall, thus, creating a “VIP” media stream.

In the depicted example, each name in the list of names in media menu 610 is associated with a “VIP” star. When a VIP star is filled in, then the associated person is said to have the VIP (i.e., very important person) status. In this example, Ralf Weber has VIP status while Renny G. does not.

In an embodiment, if a media item is not associated with any name that is associated with a VIP status, then that media item is not considered as a candidate when determining which media items to display in a media wall. For example, if the only name that a media item is associated with is Renny G., then that media item will not be displayed.

In a related embodiment, whether a media item is associated with a person with VIP status is a factor in only certain display modes. For example, location and time-based queries for media items may not consider VIP status while a default (or initial) query at startup may utilize VIP status.

### Similar Names

In an embodiment, media browser 112 (or another associated component) analyzes names that are associated with media items from multiple sources (whether local or remote) to determine which names match. The names are reflected in metadata associated with the media items. If there are any differences between names from different sources, then the names are treated as being names of different people. For example, “Rachel M.” may have been identified in data from remote source 132 and “Rachel R. M.” may have been identified in data from remote source 134. Alternatively, even if there are differences between names from different sources, the names are analyzed to determine whether they should be treated as identifying the same individual. This latter analysis may involve determining how close the names are to each other or whether there are common misspellings of one or more of the names.

Additionally or alternatively, the analysis may involve analyzing metadata from multiple sources. For example, birthday information indicated in metadata of multiple media items may be used to determine that two names that are similar (but not the same) are of the same person (if, for example, the birthdates are the same) or are of different people (if, for example, the birthdates are different).

Additionally or alternatively, the analysis may involve analyzing content of media items associated with the different names to determine if the names are of the same person. For example, (1) a first digital image associated with one name from a first source and (2) a second digital image associated with another name from a second source may be analyzed to determine whether a face detected in the first digital image is of the same person as a face detected in the second digital image.

If media browser 112 determines that two different names are (or should be) associated with the same person, then media browser 112 stores name association data that associates both names with each other. Later, when the list of names is displayed, both names may be displayed as being associated with each other. Thus, when displaying media items associated with at least one of the names, media browser 112 analyzes the name association data to determine whether the name is associated with one or more other names that have been identified as identifying the same person.

A user may be allowed (through one or more user interface controls (not shown)) to “break” a name association, after which media browser 112 stores name disassociation data that identifies both names and that indicates that both names should not be considered to be of the same person.

Similarly, a user may be allowed to select and “combine” two or more names that are included in the list of names. In response, media browser 112 stores name association data that identifies the two or more names. For example, “Ralf Weber” that is identified in remote source 132 may be known as “TRex83” in remote source 134. If media browser 112 first compares names to determine commonality, then it is unlikely that media browser 112 would ever consider the names “Ralf Weber” and “TRex83” as possibly identifying the same person.

### People-Centric Browsing

In FIG. 6, a user selects the name “Ralf Weber.” In response to selecting the name “Ralf Weber” in the list, media browser 112 identifies media items that are associated with the name “Ralf Weber.” Attributes of a media item (such as author name, date, time, location, comments, likes, tags, face recognition name(s)), may be included (from a source) in a file that contains the media item or may be sent separate from, but in association with, a media item. For example, a tag “Ralf Weber” may be identified in metadata of a file that contains a media item.

FIG. 7 is a screen shot that depicts a media wall 700 after the name “Ralf Weber” has been selected in the screen shot of FIG. 6, in an embodiment. Each media item in media wall 700 is associated with “Ralf Weber” in some way. For example, a media item in media wall 700 may have been tagged with the name “Ralf Weber” by the user of media browser 112 or an entirely different user. As another example, a media item in media wall 700 may be from a social media account of Ralf Weber. As another example, face pattern detection and recognition may been performed on a media item in media wall 700 to determine that “Ralf Weber” has been identified in the media item. As another example, Ralf Weber may have commented on a media item in media wall 700. In each of these examples, data is stored that associates Ralf Weber with the appropriate media item. The media items in media wall 700 may be ordered based on time, location, and/or any other criterion. Again, media items in media wall 700 may be from different sources. For example, one source may be a social media account of Ralf Weber. Media wall 700 also includes a navigation button 710, which has a label of “Ralf Weber.” Selection of navigation button 710 causes a media menu 810 in FIG. 8 to be displayed.

FIG. 8 is a screen shot that depicts media menu 810, in an embodiment. Media menu 810 includes a “Show All” option, a “Smart Groups” option, and a list of VIPs. The list of VIPs may include all the names that a user has selected as having the VIP status. In this example, the names of VIPs include “Axelle Tessandier,” “Eric Circlaeys,” and “Ralf Weber.” Media wall 700 in FIG. 8 is similar to media wall 700 of FIG. 7 except that, in FIG. 8, the media items in media wall 700 are dimmed or darkened. Such an effect focuses the user on media menu 810 and impending change in media items that will be displayed in media wall 700. In this example, the user selects the name “Eric Circlaeys.”

FIG. 9 is a screen shot that depicts a media wall 900 after another VIP name has been selected from media menu 810, in an embodiment. The media items in media wall 900 may be ordered based on time, location, and/or any other criterion. Again, media items in media wall 900 may be from different sources. Media wall 900 also includes a navigation button 910, which has a label of “Eric Circlaeys.”

FIG. 10 is a screen shot that depicts a media wall 1000 after the “Show All” option in media menu 810 has been selected, in an embodiment. Media wall 1000 includes media items associated with different people whose names have been given the VIP status. For example, media item 1020 may be associated with the name “Ralf Weber” and media item 1030 may be associated with the name “Eric Circlaeys.” Media items 1020 and 1030 may be from the same source (e.g., remote source 132) or from different sources (e.g., local storage 114 and remote source 134). For instance, media items associated with Eric Circlaeys may be from any of remote sources 132-136 or from local sources.

Media wall 1000 includes “bubble” icons on some of the media items. A bubble icon on a media item indicates that one or more comments are associated with the media item. The one or more comments include text from different users and/or indications that other users “liked” the media item. For example, media item 1020 may have been retrieved from remote source 132 and, at remote source 132, the one or more comments were stored in association with a copy of media item 1020. Previously, media item 1020 (or a copy thereof) may have been originally uploaded to remote source 132, which allowed “friends” (or contacts) of the user to comment on media item 1020. In an embodiment, if a user selects a bubble icon, such as bubble icon 1022, then the comments associated with the associated media item are displayed.

FIG. 11 is a screen shot that depicts media wall 1100 that is displayed in response to user selection of navigation button 1010, in an embodiment. The screen shot display media menu 1110 having selectable menu options corresponding to different libraries or media sources. Media menu 1110 lists four library items or sources from which at least some media items in media wall 1000 can be retrieved. The four listed library items include Instagram, Flickr, Facebook, and “Kjells' iPad.” Media menu 1110 allows a user to select a source where the media items can be retrieved. The source “Kjell's iPad” may be the same device that displays media wall 1000. Alternatively, the source “Kjell's iPad” may be a different device than that which displays media wall 1000. For example, media wall 1000 may be displayed on a laptop computer owned by Kjell while a tablet computer contains a media item that is displayed in media wall 1000. In some embodiments, when a user selects one of the library menu options, a second menu is displayed providing a user with a second set of menu retrieval options associated with the selected library or source. FIGS. 12 and 13 illustrate example embodiments.

FIG. 12 is a screen shot that depicts a media menu 1210 that is displayed in response to user selection of the library item labeled “Facebook” in media menu 1110 of FIG. 11, in an embodiment. Media menu 1210 has a label of “Facebook.” Media menu 1210 lists six items: “My Media,” “Smart Groups,” “Tagged,” “Albums,” “My Videos,” and “Friends.” Each item in the list allows a user to view media items that are associated with one or more criteria indicated by the corresponding item. For example, selecting the “Friends” item causes media items that depict or are otherwise associated with “friends” of a user to be identified and displayed. Thus, if the user has a friend that is reflected in a digital image or that commented or “liked” the digital image, then that digital image is identified and displayed on a new media wall.

FIG. 13 is a screen shot that depicts a media menu 1310 that is displayed in response to user selection of the “Albums” item listed in media menu 1210 of FIG. 12, in an embodiment. Media menu 1310 has a label of “Albums.” Media menu 1310 lists nine different albums that have been established by the user at the social network provider Facebook. Media menu 1310 also indicates, for each album, a number of media items associated with each album. Each album may not be associated with a unique set of media items. For example, the album “Profile Pictures” and the album “Timeline Photos” might both contain or identify the same media item. If a user selects one of the albums, then the media items from that album will be displayed on the media wall.

### Smart Groups

Media browser 112 allows a user to restrict the scope of media items that are displayed in a media wall by allowing the user to select a group or album. However, there are many cases where such a selection is not what users desire or how users naturally look for media items. Many times, if users want to tell a story or find a picture, they will look for media items that were created (or taken) during a particular time period, in a particular place, or with particular people.

In an embodiment, media browser 112 allows a user to view different “smart groups.” A “smart group” is a group of media items that media browser 112 establishes based on metadata of the media items. In other words, the source from which the media items were retrieved does not create or establish the group. “Smart groups” is one way in which media browser 112 leverages metadata of multiple media items to form new groups. Smart groups allow a user to show all the media items (that satisfy certain criteria) across all (or multiple) of the user's associated sources.

Each smart group is associated with a different type of grouping criteria. For example, a location-based smart group is based on location-related grouping criteria while a temporal-based smart group is based on temporal grouping criteria. Once a smart group is selected, media items from a set of media items are analyzed based on grouping criteria associated with the smart group.

FIG. 14 is a screen shot that depicts a media menu 1410 in response to user selection of the “Smart Groups” item listed in media menu 1210 of FIG. 12, in an embodiment. Media menu 1410 has a label of “Smart Groups.” Media menu 1410 lists five different user-selectable “smart groups.” The five smart groups listed in media menu 1410 are “Places,” “Times,” “Faces,” “Most Popular,” and “Recently Commented.”

FIG. 15 is a screen shot that depicts a media menu 1510 that is displayed in response to user selection of the “Places” smart group listed in media menu 1410 of FIG. 14, in an embodiment. Media menu 1510 has a label of “Places.” Media menu 1510 includes a map that includes four pins, each identifying a different location on the map. Each location is associated with one or more media items. The location associated with a media item may be based on location data retrieved from the source from which the media item was retrieved. Alternatively, media browser 112 may determine the location of a media item determined based on an analysis of content of the media item. For example, if the Eiffel tower is recognized in a media item, then media organizer 112 stores the location “France” in association with the media item.

In order to generate the map, media browser 112 analyzes location data associated with each media item retrieved from a particular source (or from multiple sources) and determines a scale of a map based on the location data. For example, the scale is determined such that a resulting map depicts each location identified in the location data, each pin (that identifies a location) is no closer than a first distance from an edge of the map, and the closest pin to the edge of the map is no further than a second distance from an edge of the map.

In an alternative embodiment, instead of displaying a map, media menu 1510 lists names of locations (e.g., country and/or city names). Media menu 1510 may also indicate, for each location name, a number of media items that are associated with the location.

FIG. 16 is a screen shot that depicts media menu 1510 after a user selects the middle pin in the map, in an embodiment. Media menu 1510 in FIG. 16 includes a display object 1600 that identifies a location associated with the selected pin and a number of media items that are associated with the location. In the depicted example, the location is the Swiss Alps and the number of media items is 25. In this example, the media items originate from multiple sources but are limited to names of people who have been designated as VIPs.

FIG. 17 is a screen shot that depicts a media wall 1700 that is generated after a user selects display object 1600 of FIG. 16, in an embodiment. Media wall 1700 includes media items that were retrieved from a single source. In this example, the source is Facebook. Even though a Facebook icon is used to indicate the source of each media item in media wall 1700, other embodiments do not include a source indicator icon. For example, if a user selected a particular source when navigating through a media menu, thus restricting the media items to display in a media wall to a single source, then a source indicator icon is not necessary.

The media items in media wall 1700 may be ordered based on one or more criteria, such as time or popularity. For example, the media items that media browser 112 determines are most popular are depicted in media wall 1700 while less popular media items are displayed later if a user scrolls through media wall 1700.

### Layout Options

In an embodiment, media items that are displayed concurrently are organized in a particular manner or layout. In a related embodiment, a user is allowed to change the manner in which media items are organized on the display.

FIG. 18 is a screen shot that depicts media wall 400 after a user selects a media layout option button 430 in FIG. 4, in an embodiment. FIG. 18 also depicts layout option menu 1800 that lists five different layout options: Organic, Condensed, Grid fill, Grid fit, and Grid 3D. In this embodiment, where a user is allowed to choose between different layout options, the layout/presentation layer is decoupled from the underlying media stream. Thus, the ability to switch between different layout options depending on particular use-cases or desired presentation styles is provided. For example, an “organic” layout may be used for a more interesting/visually appealing presentation for browsing purposes, whereas a “condensed” layout may be used for a more “functional” presentation, which may be more appropriate for a user to manage his/her media.

Because media wall 400 is displayed according to an “organic” layout, the “Organic” option is visually distinguished relative to the other layout options. In an “Organic” layout, aspect ratio is not preserved, although aspect ratio preservation may be preferred. In the “Organic” layout option, cropping may be performed, for example, for panoramic images.

FIG. 19 is a screen shot that depicts a media wall 1900 that includes media items that are displayed in a condensed layout format, in an embodiment. Some of the media items in media wall 1900 are also in media wall 400. In this example, media wall 1900 is displayed after a user selects the “Condensed” layout option listed in menu 1800 of FIG. 18. The media items in media wall 1900 all have the same height but some have different widths. Thus, the “condensed” layout preserves the aspect ratio of each media item. No cropping of media items is performed in the condensed layout. The condensed layout is useful in case there are one or more panoramic pictures.

FIG. 20 is a screen shot that depicts a media wall 2000 that includes media items that are displayed in a grid fill layout format, in an embodiment. Media wall 2000 comprises a grid of cells, each cell including a different media item. Some of the media items in media wall 2000 are also in media wall 400. In this example, media wall 2000 is displayed after a user selects the “Grid Fill” layout option listed in menu 1800 of FIG. 18. Each cell has the same size and dimensions. If a media item does not have an aspect ratio that matches the dimensions of a cell, then the media item is cropped and/or scaled in one dimension in order to “fill” the cell. For example, media item 1910 in FIG. 19 is the same as media item 2010 in FIG. 20, except that media item 2010 is a scaled and cropped version of media item 1910.

FIG. 21 is a screen shot that depicts a media wall 2100 that includes media items that are displayed in a grid fit layout format, in an embodiment. Media wall 2100 comprises a grid of cells, each cell including a different media item. Some of the media items in media wall 2100 are also in media wall 400. In this example, media wall 2100 is displayed after a user selects the “Grid Fit” layout option listed in menu 1800 of FIG. 18. Each cell has the same size and dimensions. Each media item is scaled (if necessary) in order to have the same height. However, instead of cropping and/or scaling a media item in order to “fill” a cell with the media item, media items are allowed to have a non-uniform width. All media items displayed in a grid fit layout have their original aspect ratios preserved. For example, media item 2110 has a height that matches the height of each other media item in media wall 2100; however, media item 2110 has a width that does not “fill” the entire cell in which media item 2110 is located.

FIG. 22 is a screen shot that depicts a media wall 2200 that includes media items that are displayed in a 3D grid layout format, in an embodiment. Media wall 2200 comprises a grid of cells, each cell including a different media item. Some of the media items in media wall 2100 are also in media wall 400. In this example, media wall 2200 is displayed after a user selects the “3D Grid” layout option listed in menu 1800 of FIG. 18. Media wall 2200 is almost the same as media wall 2000 (which has the “Grid Fill” layout format), except that the media items in media wall 2200 are displayed with a curved wall effect, such that the media items that are in the left and right-most columns of media wall 2200 appear to be visually closer to a user than the media items that are in the center columns of media wall 2200 providing a 3D viewing effect.

### Group by Options

In an embodiment, once a set of media items is determined for a media wall based on one or more stream criteria, the set of media items may be further grouped according to one or more grouping criteria. For example, a stream criteria associated with a media wall may be all media items associated with “Ralf Weber.” Then, the media items associated with “Ralf Weber” are grouped by location, such that media items associated with Paris, France are grouped (and displayed) separately from media items associated with London, England. The one or more criteria that is used to group media items that belong to a media stream are referred to herein as “group by criteria.” The group by criteria is compared to metadata or properties associated with media items in a media stream to determine how to group the media items.

FIG. 23 is a screen shot that depicts media wall 400 after a user selects a group by option button 440 in FIG. 4, in an embodiment. FIG. 23 also depicts a group by option menu 2300 that lists five different types of group by options: Date, Location, Region of Interests, Media Properties, and Social. Some types of group by options include multiple sub-options. Because the media items in media wall 400 are not grouped according to any group by option, an “Off” indicator in menu 2300 is highlighted.

FIG. 24 is a screen shot that depicts a media wall 2400 after a user selects the “Country” group by option in menu 2300 of FIG. 23, in an embodiment. In response to selection of the “Country” group by option, media browser 112 may select a country from among a plurality of countries based on one or more criteria. The criteria may include the country that is associated with the most media items (relative to other countries), the country that is associated with the most recently created (or uploaded) media item, and/or an alphabetical ordering by country name.

Alternatively, a user may have selected “Location” and, in response, media browser 112 groups images based on location. Media browser 112 may select the type of location based on one or more criteria. The groups may be based on city, state or province, country, continent or any other geographical boundaries, whether legal-based or not (such as a forest or desert that spans multiple countries).

Further, different groups based on location may correspond to different types of locations. For example, multiple groups may be based on different cities, another group may be based on particular country, and another group may be based on a forest that spans multiple states or provinces. Such a scenario may be useful if a user is associated with only a few media items in a foreign country (relative to the user) but is associated with many media items in the user's country.

Returning to FIG. 24, once a country is selected, media browser 112 assigns media items to one of multiple groups, each of which is associated with a different country. In the depicted example, one of the countries is France. Media wall 2400 includes a label 2410 that identifies the country with which the media items are associated.

FIG. 25 is a screen shot that depicts a media wall 2500 after a user has scrolled through media items associated with France, in an embodiment. Media wall 2500 includes a label 2510 that identifies Mexico and that indicates that media items to the right of the label 2510 are associated with Mexico. Thus, media wall 2500 includes media items associated with Mexico (to the right of label 2510) and media items associated with another country (to the left of label 2510), such as France.

The screen shot of FIG. 25 also includes label 2520, which is a larger visual cue that indicates that media items associated with a different location are now being displayed. In this example, label 2520 is a HUD, similar to the HUD described previously with respect to accelerated scrolling. Media browser 112 may temporarily display label 2520, for example, for two seconds after one or more media items associated with Mexico are displayed. Or media browser 112 may only display label 2520 if the user is scrolling through the media items at a particular speed. In the depicted example, label 2520 identifies the specific country with which the media items in media wall 2500 are associated.

FIG. 26 is a screen shot that depicts media wall 2500 after a user selects group by option button 2610, in an embodiment. The media items in media wall 2500 have become dimmed. Selection of group by option button 2610 also causes (1) group by option menu 2620 to be displayed and (2) the media items in media wall 2500 to be dimmed or darkened. Group by option menu 2620 is similar to group by option menu 2300, except that the “Country” label in group by option menu 2620 is highlighted and is associated with an arrow icon 2630.

In an embodiment, when a group by option (e.g., “Country”) has already been selected and a group by option button (e.g., button 2610) is selected, then, in response, a “drill down” indicator data is displayed to allow a user to select a subset of the groups that are created based on the group by option. Arrow icon 2630 is an example of “drill down” indicator data.

FIG. 27 is a screen shot that depicts media wall 2500 after a user selects arrow icon 2630 in group by option menu 2620 of FIG. 26, in an embodiment. Selection of arrow icon 2630 causes country option menu 2710 to be displayed in place of group by option menu 2620. Country option menu 2710 lists seven options, each of may be selected by the user. Thus, if the user selects “Norway,” then media browser 112 identifies media items that are associated with the country Norway and displays at least a subset of those media items.

Six of the seven options identify a different country. The last of the listed options is “Unspecified”, which indicates that media items that are assigned to the “Unspecified” group are not associated with any country or at least that media browser 112 is unable to determine with which countries those media items are associated. For example, a media item might not be associated with geographical coordinates or any other location information. Thus, the media item cannot be assigned to any particular country. As another example, a media item might be associated with geographical coordinates or any other location information but media browser 112 might not be configured to derive the country based on such information.

However, in an embodiment, media browser 112 is configured to determine a country (or other location type, such as city or state) associated with a media item even though metadata associated with the media item does not specify the country (or other locale). For example, if a media item is associated with geographical coordinates, then media browser 112 uses map data and the geographical coordinates to determine the country that corresponds to the geographical coordinates. As another example, if a media item is associated with a name of a geographical area or a city, then media browser 112 uses mapping data and the name to determine the country associated with the area name or city name. As another example, media browser 112 may analyze a media item to detect and identify an object depicted in the media item (such as the Eiffel Tower or the Great Sphinx of Giza). Media browser 112 then uses mapping data that associates objects with locations, which may include a country, to determine the country associated with the media item.

FIG. 28 is a screen shot that depicts a media wall 2800 after a user selects the “Faces” option in menu 2300 of FIG. 23, in an embodiment. In response to selection of the “Faces” option, media browser 112 may select peoples' names from among a plurality of names based on one or more criteria. The criteria may include which people are most popular, the people that are associated with the most media items, the people that are associated with the most recently created (or uploaded) media items, the people that are associated with VIP status, and/or an alphabetical ordering by person name. In the depicted example, the names (and, thus, the corresponding media items) are alphabetically ordered based on first name. Thus, because media item 2810 in media wall 2800 is associated with the person name “Alain V” and media items 2820 are associated with the person name “Alex P,” media item 2810 is displayed “before” (or to the left of) media items 2820.

FIG. 29 is a screen shot that depicts a media wall 2900 after a user selects the “Day” option in menu 2300 of FIG. 23, in an embodiment. Media items are ordered on media wall 2900 by day, such that media items on the left side of media wall 2900 are associated with a day that is earlier than media items on the right side of media wall 2900. In the depicted example, media browser 112 displays (at least temporarily) a date label 2910 that identifies a date that is associated with at least some of the media items in media wall 2900. For example, the date label 2910 may be displayed if the user is scrolling through media items at a certain speed. As another example, date label 2910 may be displayed whenever a set of media items are displayed (e.g., as a result of scrolling through media items) that are associated with a date that is different than a date associated with a set of previously-displayed media items.

### Painting Selection

In an embodiment, media browser 112 allows a user to select multiple unselected media items with a combination of touchscreen gestures, referred to herein as “painting selection” gestures.

For example, a long touch on an unselected media item causes “painting selection” mode to be entered. Entering the painting selection mode causes scrolling to be locked, such that as the user moves his finger, additional media items will be displayed and currently-displayed media items will not “move off” the display.

A selected media item may be distinguished from an unselected media item in one of many ways, examples of which include a border of the selected media item being highlighted and a translucent color overlay on the selected media item.

Without releasing the finger that engaged the painting selection mode, the user drags over media items that the user desires to select. If the user drags his finger over media items that are already selected, those media items remain selected. Once the user's selection is complete, the user releases his finger from the touchscreen. At this point, the media wall becomes “scrollable” again.

In an embodiment, the painting selection gestures are used to deselect selected media items, regardless of how the media items were selected. For example, while seven media items on a media wall are selected, a user holds a finger on a selected media item until “painting deselection” mode is entered. Entering the painting deselection mode causes scrolling to be locked. Without releasing the finger that engaged the painting deselection mode, the user drags over media items that the user desires to deselect. If the user drags his finger over media items that are already unselected, those media items remain unselected. Once the user's deselection is complete, the user releases his finger from the touchscreen. At this point, the media wall becomes “scrollable” again.

In an embodiment, while a media wall is in a painting selection (or deselection) mode, a user is able to scroll through the media wall without selecting (or deselecting) media items. Thus, for example, while in painting selection mode and while the user's finger is over a selected media item, a second finger of the user is detected, which causes painting selection to be paused and scrolling to be re-enabled. The user's second finger may drag across the touchscreen, causing the media wall to be scrolled and new media items to be displayed. After the second finger is released, the painting selection mode is reengaged and scrolling is disabled. Selection of media items begins once the first finger moves. Thus, a user may pause scrolling, lift the second finger, and then scroll again with the second finger without selecting the media item that stopped underneath the first finger.

### Filtering Based on a Selected Media Item

In some instances, a user may desire to see more media items that are similar in some way to a particular media item in a media wall. Examples of similarity include time (such as date or month), location, and people. For example, a user may see a person reflected or depicted in a digital image in a media wall that is organized based on time and then desire to see other media items associated with that person.

Thus, in an embodiment, media items that belong to a media wall are “filtered” based on input relative to a particular media item in the media wall. The user selects the particular media item and selects an appropriate filter. For example, a user selects a digital image that depicts a particular person. The selection may involve (a) double-clicking the digital image or (b) a two-finger long tap gesture. The selection causes a filter UI to be displayed. The filter UI may indicate multiple filter options, such as “Filter same Day,” “Filter same Month,” “Filter same City,” or “Filter these People.”

Once a filter is selected, media items that are associated with the selected media item and are associated with the same filter criteria as the selected media item are highlighted. For example, a user selects “Filter same Day” after selecting a particular media item in a media wall. All other media items (in the media wall) that are associated with the same day as the particular media item are highlighted. “Highlighting” media items may instead involve causing other media items (i.e., that do not “match” a particular media item based on a selected filter) to be dimmed or darkened.

Once a subset of the currently-displayed media items are highlighted (at least relative to one or more other media items in a media wall), a user may scroll through the media wall and see other media items that are highlighted, which indicates that those media items share a criterion (corresponding to the selected filter) in common with the user-selected media item.

In a related embodiment, instead of highlighting media items relative to other media items that are not associated with the same filter criteria as the selected media item, a new media wall is created where the only media items that are included in the media wall are media items that are associated with the same filter criteria as the selected media item. Thus, the new media wall may include a strict subset of the media items that are included in the “unfiltered” media wall.

### Leveraging the Media Browser Through a Separate Application

In an embodiment, the capabilities provided by media browser 112 are leveraged by one or more other applications. Thus, while some examples above describe media browser 112 as a standalone application, another application may integrate media browser 112 into its own functionality or employ an API to leverage the media browsing capabilities of media browser 112. Any application where a user desires to browse media items, such as a photo library, may be able to use media browser 112 as a service, which may be provided by an operating system.

The application may be any software application that allows a user to include or “attach” media items, such as an email application, a word processing application, a media presentation application, a photo management application, etc. For example, if the application is an email application, then a user might want to include a media item as an attachment to an email. Thus, the user may leverage media browser 112 by having the email application communicate with media browser 112 in order to receive and display media items provided by media browser 112. Thus, media browser 112 may be used as a tool by a developer of a software application so that the developer does not have to worry about developing the media item retrieval or the display of media items themselves.

FIG. 30 is a screen shot of a display provided by an application that is separate from media browser 112, in an embodiment. The display depicted in FIG. 30 includes text 3002 that invites a user to add media to a media insertion region 3004 of the display. The display depicted in FIG. 30 also includes “Media Popover” button 3010 and a “Media Board” button 3020.

FIG. 31 is a screen shot that depicts a media menu 3100 that is generated in response to user selection of “Media Popover” button 3010 in FIG. 30, in an embodiment. Media menu 3100 is similar to media menu 510 in FIG. 5. Media menu 3100 includes five options: an “All My Media” option, a “Smart Groups” option, a “People” option, a “VIP” option, and a “Library” option. Each of the listed options allows a user to select one or more criteria that is used to determine which media items (from multiple sources) to display and, optionally, how to display those media items.

FIG. 32 is a screen shot that depicts a media popover 3200 in response to user selection of the “All My Media” option in FIG. 31, in an embodiment. Media popover 3200 is similar to a media wall in that media popover 3200 includes media items from multiple sources, such as remote sources 132-136. A user is able to scroll through the media items included in media popover 3200, similar to a media wall. However, due to the relatively small size of media popover 3200, the media items in media popover 3200 are displayed in a grid fill layout format.

FIG. 33 is a screen shot that depicts media popover 3200 of FIG. 32 in response to user selection of multiple media items, in an embodiment. A user may select multiple media items in media popover 3200 in a variety of ways. For example, a user utilizes the painting selection gestures described previously to select the media items. As another example, a user utilizes a cursor control device to select one media item and, while holding down on a button on the cursor control device, move a cursor over the media items to select. In the depicted example, selected media items in media popover 3200 are visually distinguished from non-selected media items using a different border color.

### Media Board

FIG. 34 is a screen shot that depicts a media board 3400 in response to user selection of Media Board button 3020 in FIG. 30, in an embodiment. Media board 3400 is similar to a media wall, such as media wall 400. In this example, however, media board 3400 is smaller than media wall 400. Media board 3400 is relatively larger than media popover 3200 and, thus, can include larger versions of media items. In this example, the media items in media board 3400 are displayed in a condensed layout format, which preserves aspect ratios, whereas media items in media popover 3200 are reduced to a square, indicating that aspect ratios are not necessarily preserved and, thus, cropping of images is involved.

FIG. 35 is a screen shot that depicts a media board 3500 in response to user selection of various options provided in media board 3500, in an embodiment. In this way, not only can media board 3500 be used as a media wall, but also as a media menu. In the depicted example, a user has selected the “Library” option, followed by the source “Kjell's iPad,” followed by the category “Photo Streams.” Under the category “Photo Streams,” there are six subcategories. Selection of one of the subcategories causes media items from that subcategory to be displayed.

FIG. 36 is a screen shot that depicts a media board 3600 in response to user selection of the “Diving” subcategory indicated in media board 3500, in an embodiment. Media items included in media board 3600 are those items that are from the source “Kjell's iPad” and are categorized under “Photo Streams.”

FIG. 37 is a screen shot that depicts a media board 3700 in response to user selection of multiple media items, in an embodiment. Media board 3700 includes media items under the “All My Media” option. Therefore, different media items in media board 3700 may be from different sources. In this example, a user has selected media items 3710, 3720, and 3730 and has provided input that indicates that the user desires to move or copy those media items onto the media insertion region 3004. Media items 3710-3730 may have been selected using the painting selection gestures described previously. After media items 3710-3730 are selected, a number “3” is displayed that indicates a number of media items that have been selected.

FIG. 38 is a screen shot that depicts a display 3800 in response to movement of media items 3710-3730 (e.g., dragging) into media insertion region 3004, in an embodiment. In display 3800, media board 3700 disappears mostly (or entirely) from view. A user may be allowed to place media items 3710-3730 anywhere on media insertion region 3004. Alternatively, media insertion region 3004 may include only a limited number of positions at which a media item may be inserted. Thus, if a user deselects media items 3710-3730 or simply fails to move media items 3710-3730 within a certain period of time (e.g., 3 seconds) while media board 3700 is mostly hidden from display, then media items 3710-3730 disappear from media insertion region 3004. Disappearing may involve a graphic effect where each media item appears to return to their respective original position within media board 3700, which might reappear unobstructed.

FIG. 39 is a screen shot that depicts a display 3900 after a user has selected positions for media items 3710-3730 on media insertion region 3004, in an embodiment. Display 3900 also includes media board 3700. Media board 3700 may reappear in response to user selection of media board button 3020. Alternatively, media board 3700 may reappear automatically after detecting that each of media items 3710-3730 has been placed on media insertion region 3004.

### Searching Media Items Through Media Browser

In an embodiment, a user is allowed to submit a query against media items in a media wall or media board. In this way, the media items may be identified without individually selecting media items and without traversing through a media menu hierarchy.

FIG. 40 is a screen shot that depicts a display 4000 after a user has selected a search query option and entered a search query, in an embodiment. Display 4000 includes a relatively small media insertion region 3004, a keyboard 4010 to allow a user to enter text for a search query, and a media board 4020 that includes media items that satisfy the search query. In this example, media board 4020 indicates that “All My Media” is the scope of the search and “New york” is the search query. The search query may be modified (e.g., normalized, spellchecked, etc.) prior to performing the search. Media board 4020 includes search results that consist of media items that are associated with “New york.”

In an embodiment, a user provides voice input that is translated into a search query that is used to search for media items that satisfy the search query. A speech recognition component (which may be part of media browser 112) receives the voice input, translates the voice input into text data, and provides the text data to media browser 112 for searching. For each criterion in the search query, the text data may indicate a type or category of the criterion. For example, a user may speak, “Show me all pictures of my girlfriend and I in New York last year.” The speech recognition component identifies people (“my girlfriend” and “I”), a location (“New York”), and a date range (“last year”). Media browser 112 searches for media items that satisfy the search criteria.

### Displaying Containers of Media Items

In the examples above, media browser 112 provides a media menu (such as media menu 510) that allows a user to select (or create) media streams and group media items within media streams. Such a media menu is text-based. In an embodiment, media browser 112 provides an icon-based menu, where each icon either corresponds to (a) a container that corresponds to (or includes) multiple containers or (b) a container that includes only media items. The former container is referred to as a “navigational group” while the latter container is referred to as a “leaf group.”

FIGS. 41-44 are diagrams that depict examples of instances of a media menu after user selections, in an embodiment. FIG. 41 depicts a media menu 4100, which includes six icons 4110-4160, each of which corresponds to a different media stream and, thus, defines a different set of media items. For example, icon 4110 corresponds to “All My Media” and visually indicates that there are at least four remote sources of media items: an iPad, Facebook, Flickr, and Instagram. Icons 4130-4160 correspond to one of those four remote sources. Icon 4120 corresponds to “Smart Groups,” which (as described previously) allows a user to create his/her own media stream that includes a custom set of media items that are determined based on one or more stream criteria.

FIG. 42 depicts a media menu 4200, which is displayed in response to user selection of icon 4140 in FIG. 41. Media menu 4200 includes at least six icons, three of which correspond to leaf groups (i.e., icons 4210, 4230, and 4250) and three of which correspond to navigational groups (i.e., icons 4220, 4240, and 4260). In the depicted example, leaf groups are visually distinguished from navigational groups using a thick border line. Another possible (or alternative) differentiator between leaf groups and navigation groups is that a leaf group shows (up to) four thumbnails of the media items included in the leaf group, while navigational groups only show one thumbnail, such as an icon that represents the group/source.

FIG. 43 depicts a media menu 4300, which is displayed in response to user selection of icon 4240 in FIG. 42. Media menu 4300 includes more icons than can be displayed in media menu 4300 simultaneously. In this example, a user provides input to scroll downward through media menu 4300 in order to view additional groups.

FIG. 44 depicts a media menu 4300, which is displayed after the user has ceased scrolling. In this figure, media menu 4300 includes at least eight icons, each of which corresponds to leaf groups. Selection of any of the eight icons will cause a media wall to be displayed that includes media items that belong to the selected group.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 45 is a block diagram that illustrates a computer system 4500 upon which an embodiment of the invention may be implemented. Computer system 4500 includes a bus 4502 or other communication mechanism for communicating information, and a hardware processor 4504 coupled with bus 4502 for processing information. Hardware processor 4504 may be, for example, a general purpose microprocessor.

Computer system 4500 also includes a main memory 4506, such as a random access memory (RAM) or other dynamic storage device, coupled to bus 4502 for storing information and instructions to be executed by processor 4504. Main memory 4506 also may be used for storing temporary variables or other intermediate information during execution of instructions to be executed by processor 4504. Such instructions, when stored in non-transitory storage media accessible to processor 4504, render computer system 4500 into a special-purpose machine that is customized to perform the operations specified in the instructions.

Computer system 4500 further includes a read only memory (ROM) 4508 or other static storage device coupled to bus 4502 for storing static information and instructions for processor 4504. A storage device 4510, such as a magnetic disk or optical disk, is provided and coupled to bus 4502 for storing information and instructions.

Computer system 4500 may be coupled via bus 4502 to a display 4512, such as a cathode ray tube (CRT), for displaying information to a computer user. An input device 4514, including alphanumeric and other keys, is coupled to bus 4502 for communicating information and command selections to processor 4504. Another type of user input device is cursor control 4516, such as a mouse, a trackball, or cursor direction keys for communicating direction information and command selections to processor 4504 and for controlling cursor movement on display 4512. This input device typically has two degrees of freedom in two axes, a first axis (e.g., x) and a second axis (e.g., y), that allows the device to specify positions in a plane.

Computer system 4500 may implement the techniques described herein using customized hard-wired logic, one or more ASICs or FPGAs, firmware and/or program logic which in combination with the computer system causes or programs computer system 4500 to be a special-purpose machine. According to one embodiment, the techniques herein are performed by computer system 4500 in response to processor 4504 executing one or more sequences of one or more instructions contained in main memory 4506. Such instructions may be read into main memory 4506 from another storage medium, such as storage device 4510. Execution of the sequences of instructions contained in main memory 4506 causes processor 4504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 4510. Volatile media includes dynamic memory, such as main memory 4506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 4502. Transmission media can also take the form of acoustic or light waves, such as those generated during radio-wave and infra-red data communications.

Various forms of media may be involved in carrying one or more sequences of one or more instructions to processor 4504 for execution. For example, the instructions may initially be carried on a magnetic disk or solid state drive of a remote computer. The remote computer can load the instructions into its dynamic memory and send the instructions over a telephone line using a modem. A modem local to computer system 4500 can receive the data on the telephone line and use an infra-red transmitter to convert the data to an infra-red signal. An infra-red detector can receive the data carried in the infra-red signal and appropriate circuitry can place the data on bus 4502. Bus 4502 carries the data to main memory 4506, from which processor 4504 retrieves and executes the instructions. The instructions received by main memory 4506 may optionally be stored on storage device 4510 either before or after execution by processor 4504.

Computer system 4500 also includes a communication interface 4518 coupled to bus 4502. Communication interface 4518 provides a two-way data communication coupling to a network link 4520 that is connected to a local network 4522. For example, communication interface 4518 may be an integrated services digital network (ISDN) card, cable modem, satellite modem, or a modem to provide a data communication connection to a corresponding type of telephone line. As another example, communication interface 4518 may be a local area network (LAN) card to provide a data communication connection to a compatible LAN. Wireless links may also be implemented. In any such implementation, communication interface 4518 sends and receives electrical, electromagnetic or optical signals that carry digital data streams representing various types of information.

Network link 4520 typically provides data communication through one or more networks to other data devices. For example, network link 4520 may provide a connection through local network 4522 to a host computer 4524 or to data equipment operated by an Internet Service Provider (ISP) 4526. ISP 4526 in turn provides data communication services through the world wide packet data communication network now commonly referred to as the “Internet” 4528. Local network 4522 and Internet 4528 both use electrical, electromagnetic or optical signals that carry digital data streams. The signals through the various networks and the signals on network link 4520 and through communication interface 4518, which carry the digital data to and from computer system 4500, are example forms of transmission media.

Computer system 4500 can send messages and receive data, including program code, through the network(s), network link 4520 and communication interface 4518. In the Internet example, a server 4530 might transmit a requested code for an application program through Internet 4528, ISP 4526, local network 4522 and communication interface 4518.

The received code may be executed by processor 4504 as it is received, and/or stored in storage device 4510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more storage media storing instructions which, when executed by one or more processors, cause:
retrieving a first set of media items from a first source;
sending, over a network, to a second source that is different than the first source, a request for media items;
receiving, from the second source, a second set of media items;
causing the first set of media items and the second set of media items to be displayed concurrently on a display screen.

2. The one or more storage media of claim 1, wherein the first source is a first device of a particular user and the second source is a second device of the particular user.

3. The one or more storage media of claim 1, wherein the first source is a device of a particular user and the second source is a social network account of the particular user.

4. The one or more storage media of claim 1, wherein:
the first source includes a first account, of a particular user, that is provided by a first party;
the second source includes a second account, of the particular user, that is provided by a second party that is different than the first party.

5. The one or more storage media of claim 1, wherein the instructions, when executed by the one or more processors, further cause:
determining which media items of a plurality of media items satisfy one or more stream criteria;
determining that a subset of the plurality of media items satisfy the one or more stream criteria;
selecting only media items from the subset for display.

6. The one or more storage media of claim 5, wherein the one or more stream criteria corresponds to one of a particular location, a particular period of time, or one or more names of one or more people.

7. The one or more storage media of claim 1, wherein the instructions, when executed by the one or more processors, further cause:
determining, from a particular set of media items that qualify for display, a plurality of groups based on one or more grouping criteria;
wherein each group of the plurality of groups includes a different set of media items from the particular set of media items;
wherein the plurality of groups includes a first group and a second group;
causing the plurality of groups to be displayed, wherein causing the plurality of groups to be displayed comprises causing the set of media items that belong to the first group to be displayed separate from the set of media items that belong to the second group.

8. The one or more storage media of claim 7, wherein the one or more grouping criteria corresponds to one of location, time range, or people.

9. The one or more storage media of claim 7, wherein causing the plurality of groups to be displayed comprises:
causing a first label that is based on the one or more grouping criteria to be displayed in conjunction with the set of media items that belong to the first group;
causing a second label that is based on the one or more grouping criteria to be displayed in conjunction with the set of media items that belong to the second group, wherein the second label is different than the first label;

10. The one or more storage media of claim 1, wherein:
the second source is a social network provider;
the request includes a request for media items of a contact of a particular user, wherein the second set of media items includes one or more media items that originated from an account, maintained by the social network provider, of the contact of the particular user.

11. The one or more storage media of claim 1, wherein:
the display is of a particular device;
the instructions, when executed by the one or more processors, further cause comprising receiving, from a first application executing on the particular device, a particular request to display a plurality of media items;
causing is performed by a second application, that is different than the first application and that is executing on the particular device, in response to receiving the particular request to display the plurality of media items.

12. The one or more storage media of claim 1, wherein the instructions, when executed by the one or more processors, further cause:
identifying, based on the second source, a set of contacts of a particular user;
causing a plurality of names to be displayed, each name of the plurality of names corresponding to a contact in the set of contacts;
receiving input that selects a subset of the plurality of names, wherein the subset includes at least two names;
establishing, as a group, a subset of the set of contacts that corresponds to the subset of the plurality of names;
determining a name associated with each media item in a set of media items;
for each media item in the set of media items, determining whether the name associated with said each media item matches a name in the subset of the plurality of names;
causing each media item in the set of media items to be displayed only if the name associated with said each media item matches a name in the subset of the plurality of names;
wherein the first and second sets of media items are a subset of the set of media items.

13. One or more storage media storing instructions which, when executed by one or more processors, cause:
sending, over a network to a first source that maintains a first account that is registered to a particular user, a first request for media items;
receiving, from the first source, a first plurality of media items;
sending, over the network to a second source that maintains a second account that is registered to the particular user and that is different than the first source, a second request for media items;
receiving, from the second source, a second plurality of media items;
causing, to be displayed concurrently on a display screen, at least a first media item from the first plurality of media items and a second media item from the second plurality of media items.

14. The one or more storage media of claim 13, wherein the instructions, when executed by the one or more processors, further cause:
prior to causing the first and second media items to be displayed concurrently, receiving first input that indicates one or more first criteria;
in response to receiving the first input, determining whether each media item in the first and second plurality of media items satisfies the one or more first criteria;
determining that the first and second media items satisfy the one or more first criteria;
causing only media items that satisfy the one or more first criteria to be displayed.

15. The one or more storage media of claim 14, wherein the one or more first criteria indicates one or more of a particular location, a particular person, or a particular time range.

16. The one or more storage media of claim 14, wherein:
determining that the first and second media items satisfy the one or more first criteria comprises determining that a set of media items satisfy the one or more first criteria;
the instructions, when executed by the one or more processors, further cause:
receiving second input that indicates a second criterion;
in response to receiving the second input:
analyzing only the set of media items to determine how to group the set of media items based on the second criterion;
creating a plurality of groups of media items, each group including a different subset of the set of media items;
causing each group of the plurality of groups to be displayed separately from each other group of the plurality of groups.

17. The one or more storage media of claim 16, wherein the second criterion is either location, person, or time.

18. One or more storage media storing instructions which, when executed by one or more processors, cause:
retrieving a first set of media items from a first source;
storing, on a particular device, authentication information for a second source that is different than the first source;
sending, from the particular device, over a network, to the second source, a request for media items, wherein the request includes the authentication information;
receiving, from the second source, as a response to sending the second request, a second set of media items;
causing the first set of media items and the second set of media items to be displayed concurrently on a display screen of the particular device.

19. The one or more storage media of claim 18, wherein:
the first source is the particular device or a second device that is registered to a particular user to which the particular device is also registered.

20. The one or more storage media of claim 18, wherein the instructions, when executed by the one or more processors, further cause:
prior to causing the first and second media items to be displayed concurrently, receiving first input that indicates one or more first criteria;
in response to receiving the first input, determining whether each media item in a set of media items that includes the first and second plurality of media items satisfies the one or more criteria;
wherein the one or more criteria indicates one or more of a particular location, a particular person, or a particular time range;
determining that the first and second media items satisfy the one or more criteria;
causing only media items that satisfy the one or more criteria to be displayed.
